(19) United States
(12) Patent Application Publication
(10) Pub. No.: US 2003/0135868 A1
(43) Pub. Date: Jul. 17, 2003

(54) Method and apparatus for programming the memory of NTSC capable devices using data contained in a video stream

(76) Inventor: Martin DeGeorge, Cinnaminson, NJ (US)

Correspondence Address: RATNERPRESTIA, P O BOX 980, VALLEY FORGE, PA, 19482-0980, US

(21) Appl. No.: 10/328,875

(22) Filed: Dec. 24, 2002

Related U.S. Application Data
(60) Provisional application No. 60/349,194, filed on Jan. 16, 2002.

(51) Int. Cl. H04N 7/16

(52) U.S. Cl. 725/152; 725/88

(57) ABSTRACT

A system and method for updating computer software in a television receiver uses digital data encoded in a television signal recorded on a video tape or digital versatile disk (DVD). The system receives the television signal and extracts the data representing the computer software from it. The system checks the extracted data and, if it is determined to be complete and correct, uses the extracted data to update the computer software in the television receiver. The digital data may be recorded as TELETEXT data, extended data services (XDS) data or closed-caption data. The system and method can control the video tape or DVD player under control of the program to customize the software or to select specific software responsive to user commands.

### CROSS REFERENCE TO RELATED APPLICATION

This application claims the benefit under Title 35 U.S.C. § 119(e) of United States Provisional Application No. 60/349,194 filed on Jan. 16, 2002, the contents of which are incorporated herein by reference.

### FIELD OF THE INVENTION

The present invention relates generally to devices which receive data signals having video information and computer software program information. In particular, it relates to a method and an apparatus for updating or entirely replacing program code and program data in the internal storage of a television receiver using data provided in at least the vertical blanking interval (VBI) of a videotape or in at least the data tracks of a DVD.

### DESCRIPTION OF THE PRIOR ART

Computer software has been an essential component of television receivers for many years. It is used, for example, to implement digital tuning, respond to commands generated by remote control units, to decode and display closed caption information and to store and implement a user-preferred configuration of the television receiver. As used herein, the term television receiver includes any device capable of receiving television signals, for example a television set, video cassette recorder (VCR) or set-top box (STB).

It may be desirable to change the operating characteristics of a television receiver by reprogramming its operating software. One way this may be done is through manual entry by a user. Current methods include manual entry by user or updating the software using a National Renewable Security System (NRSS) smart card, as disclosed in U.S. patent application Ser. No. 10/047,553 entitled METHOD OF PROVIDING A CODE UPGRADE TO A HOST DEVICE HAVING A SMART CARD INTERFACE, and using data contained in a broadcast signal, such as disclosed in U.S. Pat. No. 5,768,539 to Metz entitled DOWNLOADING APPLICATIONS SOFTWARE THROUGH A BROADCAST CHANNEL.

While the first of these methods allows a user to update the software in his system at a time chosen by the user, it requires the preparation of an NRSS smart card and allows only limited methods for providing instructional material concerning the update. The second method, because the programming data may be sent with a television signal, allows the provider to add video instructional material. This method, however, requires the user to have the television receiver turned on when the signal is broadcast in order to receive the update.

In addition, neither of these methods provides an easy-to-use method for allowing a user to select optional data or to customize the update.

It would be advantageous to provide an economical method for updating software in a television receiver while providing instructional or other interactive content, in video form, at a time chosen by the user.

### SUMMARY OF THE INVENTION

The present invention is embodied in a system for updating computer software in a television receiver using data encoded in a television signal recorded on a video tape or digital versatile disk (DVD). The system receives the television signal and extracts the data representing the computer software from it. The system checks the extracted data and, if it is determined to be complete and correct, executes the extracted computer software or uses the extracted software to update the computer software in the television receiver.

According to one aspect of the invention, as the data is being extracted and the computer software is being updated, the video program is providing instructional information to the user regarding the update.

According to another aspect of the invention, the television receiver includes an interface for controlling the playback of the television signal and the television receiver further includes a facility by which a user may select options that cause the television receiver, under control of its computer software, to affect the playback of the television signal in order to change the data that is being received and the corresponding television signal.

According to yet another aspect of the invention, the television receiver includes an interface for controlling the playback of the television signal and the television receiver further includes a facility to cause the television receiver, under control of its computer software, to affect the playback of the television signal in order to change the data that is being received and the corresponding television signal, without user intervention.

### BRIEF DESCRIPTION OF THE DRAWINGS

FIG. 1 is an isometric drawing, partly in block diagram form which illustrates a combination digital television set-top box, television display device, and VCR that are useful for describing the subject invention.

FIG. 2 is a block diagram of a system that can be used to update data in a television receiver

FIG. 3 is a flow-chart diagram that is useful for describing the downloading process used by the present invention.

FIG. 4 is a flow-chart diagram that is useful for describing the method by which the television receiver controls the video signal source according to the present invention.

### DETAILED DESCRIPTION OF THE INVENTION

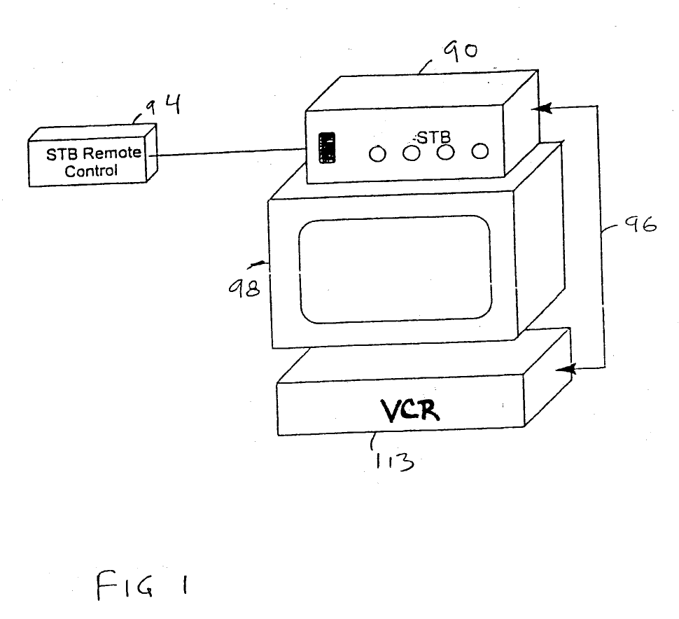

FIG. 1 is a block diagram which illustrates an exemplary system configuration according to the present invention. In this system configuration, a digital television receiver 90 is coupled to display video information on a video display device 98. In the exemplary embodiment, receiver 90 is a set-top box (STB) which may be coupled to receive digital and analog television signals from a signal supplier via a satellite dish, a terrestrial antenna, and a cable connection. It is contemplated, however, that it may be an analog television receiver having an integrated display device (not shown). In the exemplary embodiment, the receiver 90 is also coupled to receive digital and analog video, audio, and data signals from a VCR 113 using a video cassette (not shown). In another embodiment, device 113 may be a digital versatile disk (DVD) (not shown) or similar device which produces an analog television signal. The VCR is coupled to receiver 90 via a communications channel 96. As described below, the VCR 113 provides the analog television signal via the channel 96 to the receiver 90. Also shown in FIG. 1 is a remote control device 94 for controlling receiver 90. In the exemplary embodiment, the data program provided by the VCR 113 consists of computer software which reconfigures receiver 90 by updating or replacing the program code and/or program data in receiver 90. In an alternative embodiment, the data program may be provided to receiver 90 from a satellite dish, a terrestrial antenna, and a cable connection.

The subject invention transfers the data from selected lines in the VBI of the television signal provided by the VCR 113 to the receiver 90. The data may be stored in various parts of the VBI. In one embodiment, it can be stored at line 21 as extended data services (XDS) data or as closed caption (cc) data while other parts of the video tape have a video and audio program. In another embodiment, it can be stored in the same area that teletext data would be stored that is, lines 6-20, again while other parts of the television signal have a video and audio program. In another embodiment, it may be stored as digital data in every line of a video signal that has no other video or audio program on it. Alternatively, the video tape or DVD may include the digital data in place of the video program but still include an audio program, for example, describing installation procedures and new features.

When a DVD player is used in place of the VCR 113, the digital data may still included in the VBI of the analog signal provided by the DVD. In this instance, the DVD may contain the data as a separate data program in the DVD and the player (not described in detail) may include circuitry that extracts the data program, formats it and inserts it into the VBI of the analog signal before providing the signal to the STB 90.

Although not shown, it is contemplated that the data transferred from VCR 113 to receiver 90 may also include verification features such as check sums or cyclic redundancy codes (CRC's) which may be processed to verify that the data is correct and complete before it is used.

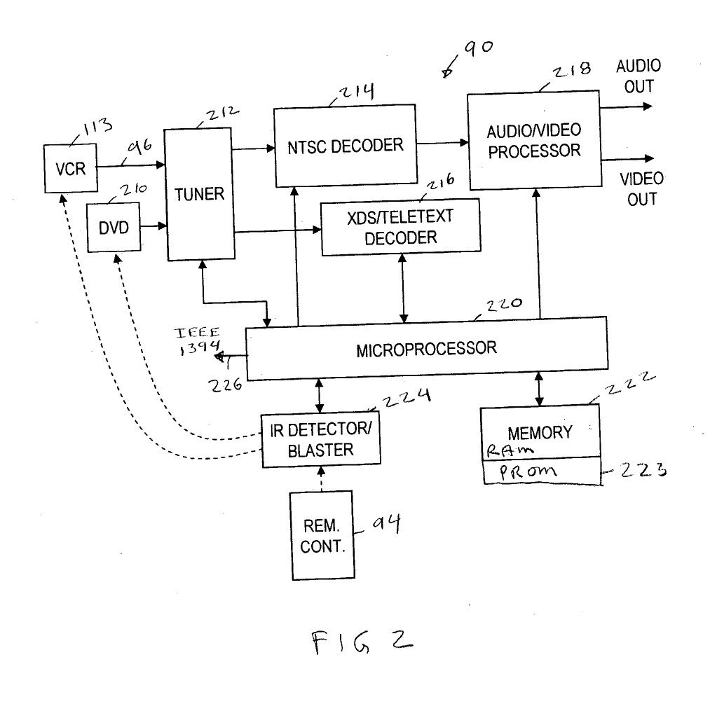

Referring to FIG. 2, the television signal including the data to be used to update the computer program instructions used by the microprocessor 220 of the STB 90 may be provided by the VCR 113 or by the DVD player 210. In the materials that follow, it is assumed that the television signal is provided by the VCR 113. One skilled in the art can readily extend the present invention to handle television signals provided by the DVD player 210. In the exemplary embodiment, the television signal is applied to a tuner 212. Tuner 212 operates under the control of a microprocessor 220 which controls the channel to which tuner 212 is tuned. The microprocessor 220 also controls other functions of the STB such as the source of television signal (e.g. VCR, DVD, cable, satellite or terrestrial broadcast). The STB may also control the appearance of the video image on the monitor 98 (shown in FIG. 1) and the volume and equalization of the audio signals by controlling the audio/video processor 218, described below. Although the tuner 212 of the STB 90 is shown as receiving the television signals it is contemplated that they may be received directly by the NTSC decoder 214 and XDS/TELETEXT decoder 216 if, for example, they are provided to the STB 90 in composite or component video form. Although the XDS/TELETEXT decoder 216 and microprocessor 220 are shown as separate devices, it is contemplated that their functions could be combined in a single processor (not shown).

The microprocessor 220 operates under control of a system program stored in programmable read-only memory PROM 223. One embodiment of the invention updates this system program. The microprocessor 220 is also coupled to random access memory (RAM) 222. This memory may be used to hold data to be used by the system program or to hold applications programs that may be downloaded from the VCR 113 or DVD 210, as described below.

In the exemplary embodiment of the invention shown in FIG. 2, after the television signals are received by the tuner 212, they are demodulated and applied to the NTSC decoder 214 and XDS/TELETEXT decoder 216. The NTSC decoder 214 separates the television signal into digital video and audio component signals and applies these signals to the audio/video processor 218. The output signals of the audio/video processor 218 are analog audio and video signals. The video signal may be applied to the monitor 98, shown in FIG. 1. The audio signals may be applied to a sound system (not shown), which may include an audio amplifier and speakers.

The XDS/TELETEXT decoder 216 extracts data from the VBI of the signal. Under control of microprocessor 220, the extracted program data is stored in random access memory (RAM) 222. Although the RAM 222 and programmable read-only memory (PROM) 223 are shown as being separate from the microprocessor 220, it is contemplated that it may be implemented within the microprocessor 220. Although the memory 223 is described as being a PROM, it is contemplated that any type of non-volatile memory, such as FLASH programmable memory, ferroelectric RAM or battery-backed complementary metal-oxide-semiconductor CMOS RAM may be used as the memory 223.

The exemplary STB 90 further includes a control interface. As shown in FIG. 2, the control interface may be implemented, without limitation, as an infrared (IR) blaster 226, integrated with the IR receiver for the remote control device 94, or as an IEEE 1394 control bus interface 226. The bus interface 226 may be used to control the VCR 113 or DVD player 210, as described below, if these devices also include control bus interfaces (not shown) and are capable of being placed in a “slave” mode. If either of the devices 113 or 210 do not include control bus interfaces or if the VCR 113 or DVD player 210 can not be placed into a slave mode, the IR blaster 224 may be used to implement the control functions. The blaster 224 is programmed with the infrared commands for the VCR and/or DVD and, thus, can control these devices in the same way as a user, using their respective hand-held remote control devices (not shown).

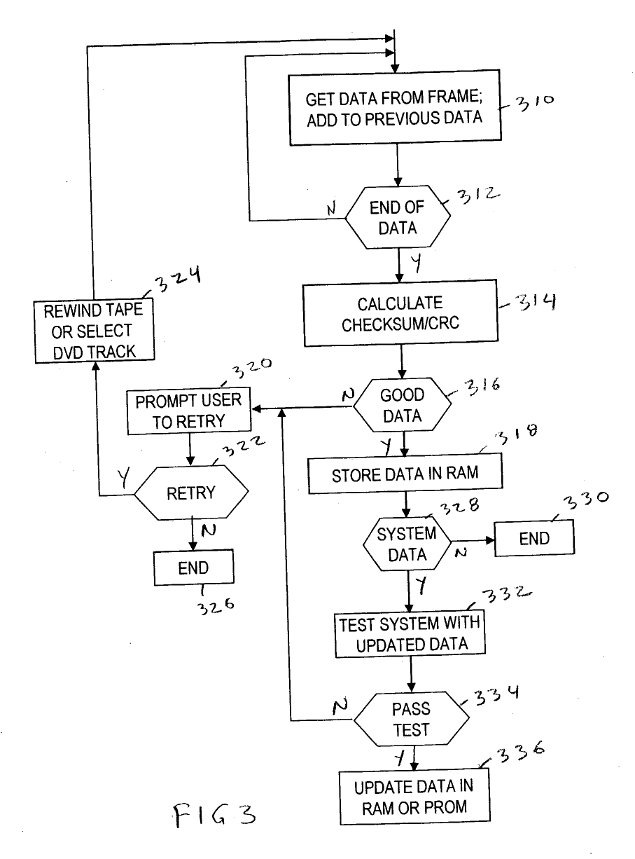

FIG. 3 is a flow-chart diagram that is useful for describing the method by which data is downloaded from the VCR 113 or DVD 210 of the present invention. As described above, the data is encoded into the vertical blanking interval of the video signal received by the STB 90. If the data is encoded as XDS or closed caption data, two characters per frame are provided by the video signal. If the data are encoded as TELETEXT or by some other method, for example, that disclosed in U.S. Pat. No. 5,309,235 entitled SYSTEM AND METHOD FOR TRANSMITTING DIGITAL DATA IN THE OVERSCAN PORTION OF A VIDEO SIGNAL, more data may be available or it may be available once per field rather than once per frame.

At step 310, the process gets the data from the field or frame and adds the new data to any data that may have been previously downloaded. At step 312, the process determines whether all of the data has been downloaded. This may be accomplished, for example, by checking for an end-of-file marker or after a fixed amount of data has been downloaded. If step 312 determines that there is more data to be downloaded, it transfers control to step 310 to continue the downloading process. If all of the data has been downloaded at step 312, the process next executes step 314 which calculates a check sum or cyclic redundancy code (CRC) value for the data that has been downloaded. In the exemplary embodiment of the invention, the correct CRC or check sum value is transmitted with the data. After step 314, the process, at step 316 compares the calculated value with the value in the downloaded data. If these values match then it is likely that the data was properly downloaded and control passes to step 318. If these values do not match, however, it is likely that the downloaded data is corrupted and control passes to step 320.

At step 320, the user is prompted, for example, by displaying a message on the display 98, shown in FIG. 1, that the download was unsuccessful and asked whether it should be attempted again. If, at step 322, the user authorizes the retry operation, the process controls the VCR 113 to rewind, for example, to an index mark corresponding to the start of the data and transfers control to step 310 to again attempt to download the data. If the DVD 210 is providing the data, step 324 may control the DVD player to select a track corresponding to the start of the downloaded data. If, at step 322, the user does not authorize the retry operation, the process terminates at step 326.

If at step 316, the calculated check sum or CRC matches the downloaded value, step 318 is executed which stores the downloaded data into the RAM 222, shown in FIG. 2. Next, at step 328, the process determines whether the downloaded data is a system program for the STB 90. If not, the process ends at step 330. If, however, the downloaded data is a system program, the process, at step 332 tests the program from RAM 222 before storing it permanently into the PROM 223.

If this test is unsuccessful, control transfers to step 320 to determine if the user wants to retry the download. Otherwise, control transfers to step 336 and the downloaded system program is stored into the PROM 223.

As described above, when computer program data has been stored into the RAM 222, it may be checked by the microprocessor using the check sum or CRC and, executed or stored into the PROM 223 only if it is found to be error-free. When this embodiment is used, the data may be transmitted two or more times to verify that a correct and complete version is received before it is used. For example, if the data is not successfully received the first time, the process can advance to the second copy automatically and only request a retry if both copies fail to download properly.

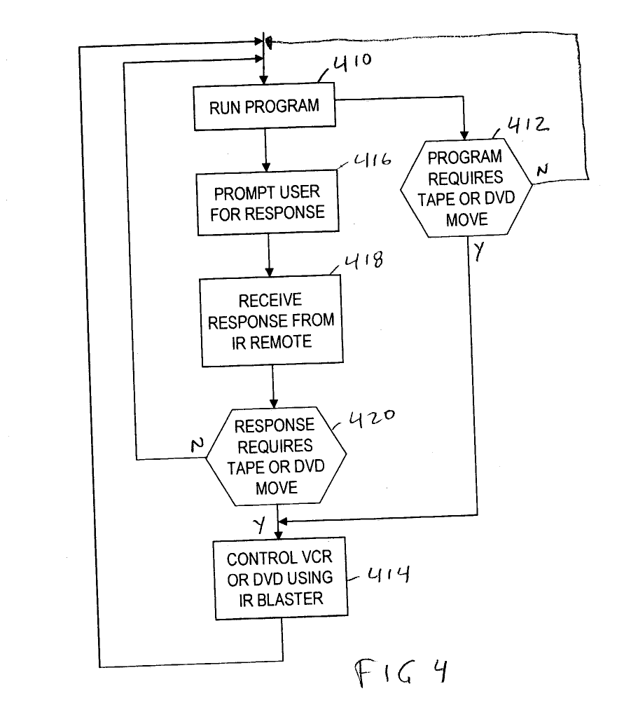

FIG. 4 is a flow-chart diagram that illustrates how the downloaded software may interact with the VCR 113 or DVD player 210 either to customize the downloaded software or to provide the user with an interactive television signal. Step 410 represents the execution of the downloaded computer software. From time to time, an interrupt may occur to request input from the user, steps 416 through 420, or to interact with the VCR 113 or DVD player 210, step 412. In this embodiment of the invention, the interaction with the VCR 113 or DVD player 210 is limited to requesting the VCR to move backward or forward to a specified index mark or to requesting the DVD player to provide data from a specified track. As shown in FIG. 4, this is accomplished at step 414 which uses the IR blaster 224 or control bus connection 226 to so control the VCR 113 or DVD 210.

If, at step 410, the process requests a response from the user, step 416 is executed which prompts the user for the desired response, for example, by displaying a message passed from step 410 on the display monitor 98, shown in FIG. 1. The process shown in FIG. 4 receives the response from the user via the remote control unit 94 and IR detector 224 shown in FIG. 2. Next, the process shown in FIG. 4 determines if the running program wants specific data from the VCR 113 or DVD player 210. If, at step 420, specific data is desired, the process executes step 414 to obtain the data and then return control to step 410. Otherwise, the process returns control directly from step 420 to step 410.

Under control of microprocessor 220, the television signals may be converted to images by the decoder 214 and processor 218 and applied to the display monitor 98. The microprocessor may, under control of the downloaded computer program stored in the RAM 222 or PROM 223, cause data to be displayed on the monitor 98 using, for example, the on-screen display function of the STB 90. This function allows the STB to overlay text or simple pre-programmed images onto the video image produced by the television signal recovered from the VCR 113 or DVD player 210.

The information contained in the VBI or the information stored in the DVD's data tracks (that is, the program information) may be cooperative with the video signal. In one embodiment, the television program information may contain instructions regarding how to use the newly-loaded computer program. In another embodiment, the television program may allow a user to control the operation of VCR 113 or DVD player 210 so that it may be stopped, started or spaced to provide predetermined television program signals in accordance with input from the user or with instructions from the computer program. This interaction may, for example, allow the user to skip among scenes or to provide alternate scenes.

In another embodiment of the invention, the VBI in the videotape, or the data tracks in the DVD, may contain data used to update the system software in the set-top box. In this embodiment, under control of microprocessor 220 the system may compare the data currently in the memory with the newly downloaded data. If the comparison shows that the newly downloaded data is more up-to-date data than the data currently stored in RAM 222 or PROM 223, microprocessor 220 may cause the more current data to overwrite the data previously stored in PROM 223 as newly written data and cause it to be displayed on monitor 98 for viewing and further interaction with a user. Comparisons between current and new data may be performed automatically and without interruption or input from a user.

The programming method and apparatus described above may be used for many purposes. For example, it may be used to upgrade an existing digital television receiver to provide additional features or to fix errors in the existing systems program code. As another example, it may be used to upgrade an existing analog television receiver for the same reasons. An upgrade or corrections may be done, for example, by placing a video tape, received from the manufacturer, into VCR 113. This video tape may include the data program and a video and audio program which describes and teaches the new features. While the viewer is watching the video program, the digital, or analog, television receiver is decoding the new program and storing it into the memory of STB 90. Alternatively, an upgrade may be done by placing, in VCR 113, a video tape that has only a current data program without additional video and audio information.

In another embodiment of the invention, the video portion of each frame being played by VCR 113 can be used to carry marketing or other informative or entertaining information during the actual programming of receiver 90.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for updating computer software in a television receiver comprising the steps of:
receiving an analog television signal generated from a recorded medium, the television signal including a data signal representing the computer software;
extracting the data signal from the analog television signal;
storing the extracted data signal into a memory;
checking the extracted data using a data value generated from the extracted data signal to determine if the extracted data signal is correct;
Updating the computer software in the television receiver if the extracted data is determined to be correct.

2. A system according to claim 1, wherein the step of receiving the analog television signal includes the step of inserting a pre-recorded video tape into a video tape player and receiving an output signal of the video tape player, the prerecorded video tape including the data signal in at least a vertical blanking interval of s a video signal recorded on the prerecorded video tape.

3. A system according to claim 1, wherein the step of receiving the analog television signal includes the step of inserting a pre-recorded digital versatile disc (DVD) into a DVD player and receiving an output signal of the DVD player, the prerecorded DVD including the data signal as part of a prerecorded video signal.

4. A system according to claim 1, wherein the step of receiving the analog television signal includes the step of inserting a pre-recorded digital versatile disc (DVD) into a DVD player and receiving an output signal of the DVD player, the prerecorded DVD including the data signal as a data track and the DVD player combining data from the data track into the analog television signal it provides.

5. A method according to claim 1, wherein the television signal includes an active video signal component and a vertical blanking component and the data signal is included in the vertical blanking component according to one of a TELETEXT, closed-caption and extended data services (XDS) protocol.

6. A method according to claim 5, wherein the active video signal component includes instructional information regarding the computer software update and the method further includes the step of displaying the instructional information while the method is updating the computer software.

7. A method according to claim 1, wherein the computer software is system software and the method further includes the steps of:
testing the system software from the memory before updating the computer software to determine if the software operates properly; and
if the software is determined to operate properly, transferring the stored software from the memory to a programmable read-only memory (PROM).

8. A method according to claim 1, wherein the television receiver includes a control mechanism that is configured to change the analog television signal provided from the prerecorded medium, and the method further includes the step of:
executing the updated computer software, the updated computer software activating the control mechanism to change the analog television signal provided from the prerecorded medium to select respective data signals to be received by the television receiver.

9. Apparatus comprising:
a prerecorded medium including computer software encoded as digital data in an analog television signal;
a television receiver including:
means for receiving the analog television signal including the digital data;
a random-access memory;
processing means which is configured to extract the data signal from the analog television signal and stores the extracted data signal into the random access memory, to check the extracted data signal using a data value generated from the extracted data signal to determine if the extracted data signal is correct and to execute the extracted data in the random access memory as the computer software if the extracted data signal is determined to be correct.

10. Apparatus according to claim 9, wherein the processing means includes:
a first processor that is configured to extract the data signal from the analog television signal and stores the extracted data signal into the random access memory; and
a second processor that is configured to check the extracted data signal using a data value generated from the extracted data signal to determine if the extracted data signal is correct and to execute the extracted data in the random access memory as the computer software if the extracted data signal is determined to be correct.

11. Apparatus according to claim 9, wherein the prerecorded medium is a video tape.

12. Apparatus according to claim 11, wherein the video tape includes the digital data recorded as at least a part of the television signal.

13. Apparatus according to claim 12, wherein the video tape includes a recorded television signal having an active video signal and a vertical blanking interval and the digital data is recorded in the vertical blanking interval as one of TELETEXT data, closed caption data and extended data services (XDS) data.

14. Apparatus according to claim 13, wherein the digital data is recorded as a XDS data and the processing means includes an XDS decoder.

15. Apparatus according to claim 13, wherein the active video signal component includes instructional information regarding the computer software update and the television receiver is configured to display the instructional information while the processing means executes the computer software.

16. Apparatus according to claim 9, wherein the computer software is system software for the television receiver and the apparatus further includes a programmable read-only memory which holds the system software, whereby the processing means transfers the software from the random access memory to the programmable read-only memory if the execution of the computer software indicates that the computer software is correct.

17. Apparatus according to claim 9, further including a control mechanism that is configured to control a programmable media player on which the programmable medium is played to produce the television signal, the control mechanism controls the programmable medium player to change the analog television signal provided from the prerecorded medium, whereby when the processing means executes the computer software, the computer software activates the control mechanism to change the analog television signal provided from the prerecorded medium to select respective data signals to be received by the television receiver.

18. Apparatus according to claim 16, wherein the control mechanism is an infrared blaster which produces infrared remote control commands for the programmable media player.

19. Apparatus according to claim 16, wherein the control mechanism is a control bus coupled between the apparatus and the programmable media player.
